(19) United States
(12) Patent Application Publication
(10) Pub. No.: US 2010/0077384 A1
(43) Pub. Date: Mar. 25, 2010

(54) PARALLEL PROCESSING OF AN EXPRESSION

(75) Inventors: Igor Ostrovsky, Bellevue, WA (US); Stephen Toub, Seattle, WA (US); John Duffy, Renton, WA (US); Joseph Hellerstein, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/236,210

(22) Filed: Sep. 23, 2008

(51) Int. Cl. G06F 9/44

(52) U.S. Cl. 717/127

(57) ABSTRACT

A method includes compiling an expression into executable code that is configured to create a data structure that represents the expression. The expression includes a plurality of sub-expressions. The code is executed to create the data structure. The data structure is evaluated using a plurality of concurrent threads, thereby processing the expression in a parallel manner.

### BACKGROUND

Software programs have been written to run sequentially since the beginning days of software development. Steadily over time, computers have become much more powerful, with more processing power and memory to handle advanced operations. This trend has recently shifted away from ever-increasing single-processor clock rates towards an increase in the number of processors available in a single computer resulting in a corresponding shift away from sequential execution toward parallel execution. Software developers want to take advantage of improvements in computer processing power to enable their software programs to run faster as new hardware is adopted. With parallel hardware, software developers arrange for one or more tasks of a particular software program to be executed in parallel (also referred to as concurrently), so that the same logical operation can utilize many processors at one time to thereby deliver better performance as more processors are added to the computers on which such software runs.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

One way to express a parallelizable computation is via an expression. For example, an expression that includes a sum of three calls to a particular method can be parallelized by performing the three method calls using three different threads on three different computational cores, cutting the execution time by up to a factor of three.

In one embodiment, an expression is compiled into executable code that creates a data structure that represents the expression. The code is executed to create the data structure. The data structure is evaluated using a plurality of concurrent threads.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a diagram illustrating a computing device suitable for performing automatic parallelization of expressions according to one embodiment.

FIG. 2 is a diagrammatic view of an automatic parallelization of expressions application for operation on the computing device illustrated in FIG. 1 according to one embodiment.

FIG. 3 is a flow diagram illustrating a method for evaluating an expression in a parallel manner according to one embodiment.

FIG. 4 is a block diagram illustrating a system for evaluating an expression in a parallel manner according to one embodiment.

FIG. 5 is a diagram illustrating an expression tree for an example expression according to one embodiment.

FIG. 6 is a diagram illustrating an expression tree for another example expression according to one embodiment.

FIG. 7 is a flow diagram illustrating a method for evaluating an expression tree using a plurality of concurrent threads according to one embodiment.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

One embodiment provides an application that performs automatic parallelization of expressions using asynchronous tasks, but the technologies and techniques described herein also serve other purposes in addition to these. In one implementation, one or more of the techniques described herein can be implemented as features within a framework program such as MICROSOFT® .NET Framework, or within any other type of program or service that handles parallel operations in programs.

Different programming languages and libraries provide different mechanisms for the developer to express what operations may be performed in parallel. This is helpful to execute the program efficiently on machines with multiple computational cores. It has not been shown to be feasible, other than in highly-constrained situations, for a compiler to be able to make this determination automatically and without any information from the developer.

One natural way to express a parallelizable computation is via expressions. An expression according to one embodiment is a combination of letters, numbers, and symbols used to represent a computation that produces a value. For example, the expression “Foo(1)+Foo(2)+Foo(3)” is naturally parallelizable, on the assumption that the method calls to Foo( ) are thread-safe. If the thread-safety assumption holds, the three different calls to Foo( ) can be run using three different threads on three different computational cores, cutting the execution time by up to a factor of three.

For example, consider the sequential code given in the following Pseudo Code Example I:

### PSEUDO CODE EXAMPLE I

int result=Foo(1)+Foo(2)+Foo(3);

One embodiment provides a developer with the ability to have the expression in Pseudo Code Example I evaluated in parallel by rewriting it as shown in the following Pseudo Code Example II:

Pseudo Code Example II

int result = ParallelExpression.Evaluate(
( ) => Foo(1) + Foo(2) + Foo(3));

At run time, the ParallelExpression.Evaluate method according to one embodiment would then process this expression in parallel using three concurrent threads (i.e., a first thread to compute Foo(1), a second thread to compute Foo(2), and a third thread to compute Foo(3), and one of these threads would then be reused to compute the sum). This approach is also applicable to more complicated nested expressions, such as the expression given in the following Pseudo Code Example III:

### PSEUDO CODE EXAMPLE III

int result=Bar(Foo(1), Foo(2)+Foo(3))+Foo(4);

In this example, all calls to the method Foo( ) may start immediately, but the call to Bar( ) is delayed until the calls to Foo(1), Foo(2), and Foo(3) complete. Once these calls complete, Bar( ) is called. Finally, once both Bar( ) and Foo(4) complete, their return values are added together. Implementing this example using traditional parallel programming techniques would involve a significant amount of development effort and provide much room for errors. One embodiment provides a developer with the ability to have the expression given in Pseudo Code Example III evaluated in parallel by rewriting it as shown in the following Pseudo Code Example IV:

Pseudo Code Example IV

int result = ParallelExpression.Evaluate(
( ) => Bar(Foo(1), Foo(2) + Foo(3)) + Foo(4));

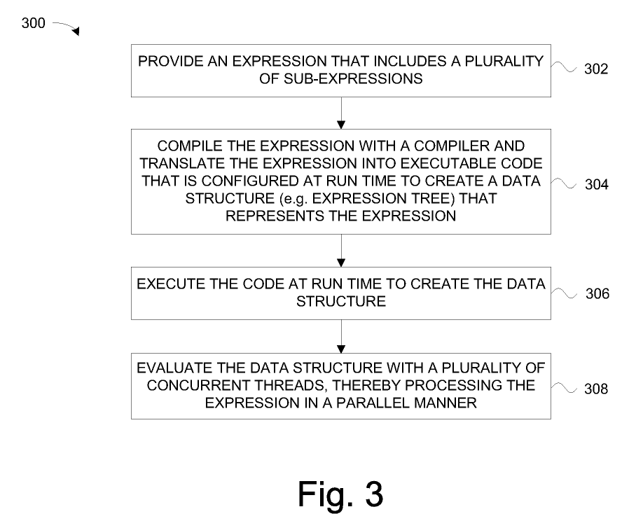

At run time, the ParallelExpression.Evaluate method according to one embodiment would then process this expression in parallel using four concurrent threads (i.e., a first thread to compute Foo(1), a second thread to compute Foo(2), a third thread to compute Foo(3), and a fourth thread to compute Foo(4), and one of these threads would then be reused to compute the sum and Bar( )). The ParallelExpression.Evaluate method according to one embodiment is described in further detail below with reference to FIG. 3.

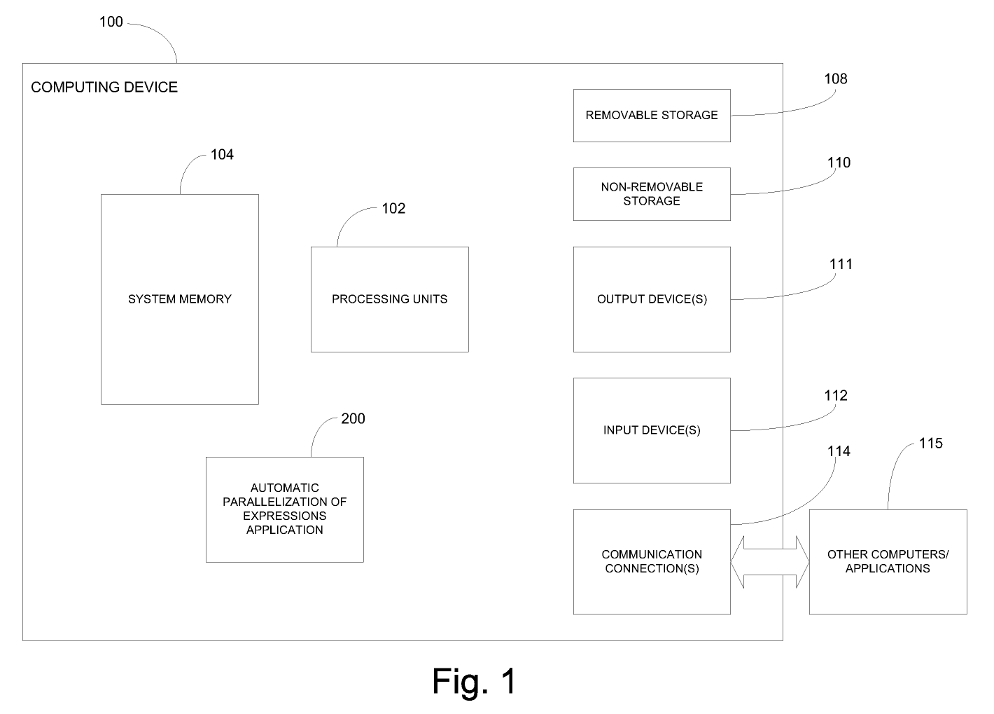

FIG. 1 is a diagram illustrating a multi-processor computing device 100 suitable for performing automatic parallelization of expressions according to one embodiment. In the illustrated embodiment, the computing system or computing device 100 includes a plurality of processing units (i.e., processors or threads) 102 and system memory 104. Depending on the exact configuration and type of computing device, memory 104 may be volatile (such as RAM), non-volatile (such as ROM, flash memory, etc.), or some combination of the two.

Computing device 100 may also have additional features/functionality. For example, computing device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by computing device 100. Any such computer storage media may be part of computing device 100.

Computing device 100 includes one or more communication connections 114 that allow computing device 100 to communicate with other computers/applications 115. Computing device 100 may also include input device(s) 112, such as keyboard, pointing device (e.g., mouse), pen, voice input device, touch input device, etc. Computing device 100 may also include output device(s) 111, such as a display, speakers, printer, etc.

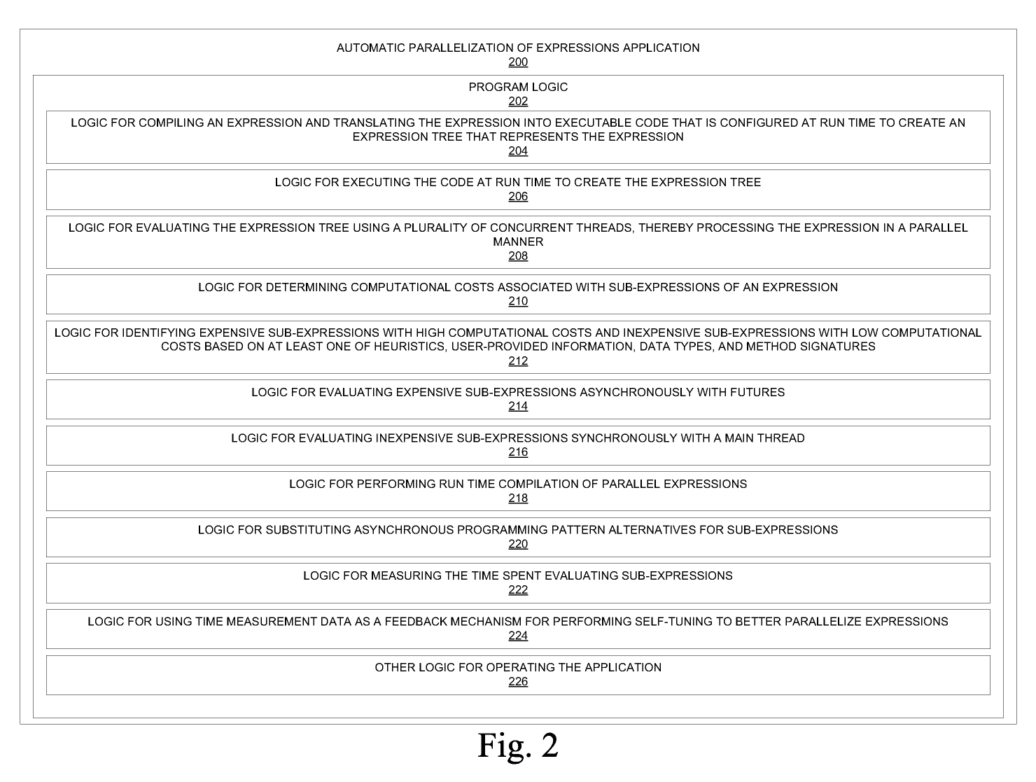

In one embodiment, computing device 100 includes automatic parallelization of expressions application 200. Automatic parallelization of expressions application 200 is described in further detail below with reference to FIG. 2.

FIG. 2 is a diagrammatic view of an automatic parallelization of expressions application 200 for operation on the computing device 100 illustrated in FIG. 1 according to one embodiment. Application 200 is one of the application programs that reside on computing device 100. However, application 200 can alternatively or additionally be embodied as computer-executable instructions on one or more computers and/or in different variations than illustrated in FIG. 1. Alternatively or additionally, one or more parts of application 200 can be part of system memory 104, on other computers and/or applications 115, or other such suitable variations as would occur to one in the computer software art.

Automatic parallelization of expressions application 200 includes program logic 202, which is responsible for carrying out some or all of the techniques described herein. Program logic 202 includes logic 204 for compiling an expression and translating the expression into executable code that is configured at run time to create an expression tree that represents the expression; logic 206 for executing the code at run time to create the expression tree; logic 208 for evaluating the expression tree using a plurality of concurrent threads, thereby processing the expression in a parallel manner; logic 210 for determining computational costs associated with sub-expressions of an expression; logic 212 for identifying expensive sub-expressions with high computational costs and inexpensive sub-expressions with low computational costs based on at least one of heuristics, user-provided information, data types, and method signatures; logic 214 for evaluating expensive sub-expressions asynchronously with futures; logic 216 for evaluating inexpensive sub-expressions synchronously with a main thread; logic 218 for performing run-time compilation of parallel expressions; logic 220 for substituting asynchronous programming pattern alternatives for sub-expressions; logic 222 for measuring the time spent evaluating sub-expressions; logic 224 for using time measurement data as a feedback mechanism for performing self-tuning to better parallelize expressions; and other logic 226 for operating the application.

Turning now to FIGS. 3-7, techniques for implementing one or more embodiments of automatic parallelization of expressions application 200 are described in further detail. In some implementations, the techniques illustrated in FIGS. 3-7 are at least partially implemented in the operating logic of computing device 100.

FIG. 3 is a flow diagram illustrating a method 300 for evaluating an expression in a parallel manner according to one embodiment. At 302, an expression including a plurality of sub-expressions is provided. At 304, a compiler compiles the expression at compile time and translates the expression into executable code that is configured at run time to create a data structure that represents the expression. At 306, the code is executed at run time to create the data structure. In one embodiment, the data structure created at 306 is an expression tree. An expression tree according to one embodiment is a non-executable data structure in which each part (e.g., method call, binary operation, etc.) of the corresponding expression is represented by a node in a tree-shaped structure. An expression tree according to one embodiment represents language-level code in the form of data.

At 308, a plurality of concurrent threads evaluate the data structure, thereby processing the expression in a parallel manner. In one embodiment, the data structure (e.g., expression tree) that was created at 306 is passed at 308 to the ParallelExpression.Evaluate( ) method, which inserts calls to other parallel libraries into the expression tree to effectively parallelize the expression. The ParallelExpression.Evaluate( ) method evaluates the expression tree at 308 using a plurality of concurrent threads, thereby effectively evaluating the expression in parallel. In one embodiment, the expression tree is directly evaluated (i.e. “interpreted”) at 308. In another embodiment, the expression tree is first compiled into machine code, which is then directly executed by a processor or a virtual machine.

In one embodiment, the ParallelExpression.Evaluate( ) method uses “futures” as the parallel construct to parallelize the evaluation of expressions. A future indicates that a program that is being executed on one thread will need the result of a computation some time in the future. The run time system can execute the future on another thread and hold the result until the program needs it, while the program concurrently continues to execute code that does not rely on the result of the future. A future according to one embodiment is an asynchronous task or operation that computes a value. An asynchronous task or operation according to one embodiment executes concurrently in a thread that is separate from the main application thread. If a procedure requests the value from a future before the computation of that future's value is complete, the future will block the procedure until the computation is done. In the Parallel Extensions to the MICROSOFT®.NET Framework, an asynchronous operation, such as a future, is represented by a task object. Launching an asynchronous operation produces an instance of a task object that can be stored and waited on as an individual entity, meaning that a thread of execution can block (i.e., pause processing) until the target asynchronous operation represented by that task object completes execution.

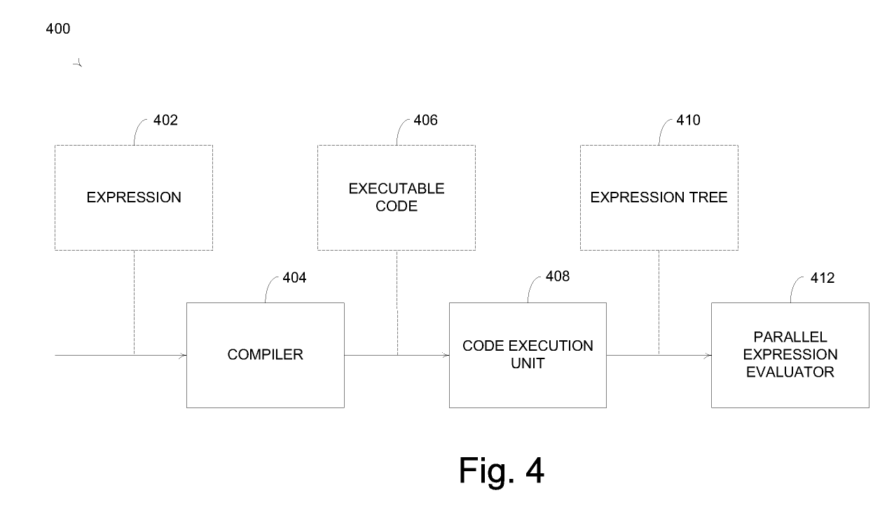

FIG. 4 is a block diagram illustrating a system 400 for evaluating an expression in a parallel manner according to one embodiment. In one embodiment, system 400 is configured to perform method 300. As shown in FIG. 4, an expression 402, which includes a plurality of sub-expressions, is provided to compiler 404. Compiler 404 compiles the expression 402 and translates the expression into executable code 406 that is configured at run time to create a data structure that represents the expression 402. The code 406 is executed at run time by code execution unit 408 to create the data structure, which in the illustrated embodiment is an expression tree 410. The expression tree 410 is provided to a parallel expression evaluator 412, which uses a plurality of concurrent threads to evaluate the expression tree 410, thereby processing the expression 402 in a parallel manner. In one embodiment, the parallel expression evaluator 412 is configured to evaluate a first portion of the expression tree 410 using a first thread, and concurrently evaluate a second portion of the expression tree 410 using a second thread. In one embodiment, the parallel expression evaluator 412 is configured to perform the ParallelExpression.Evaluate( ) method, which was discussed above.

Method 300 and system 400 will now be described in further detail with reference to a binary tree example. Pseudo code for computing the sum of values in all nodes in a binary tree is given in the following Pseudo Code Example V:

Pseudo Code Example V

```
public static int SumTreeParallel(Node root, int depth)
{
  if (root == null) return 0;
  if (depth == 0) return SumTreeSequential(root);
  return ParallelExpression.Evaluate(
    ( ) => SumTreeParallel(root.Left, depth−1)
      + SumTreeParallel(root.Right, depth−1)
      + root.Value);
}
```

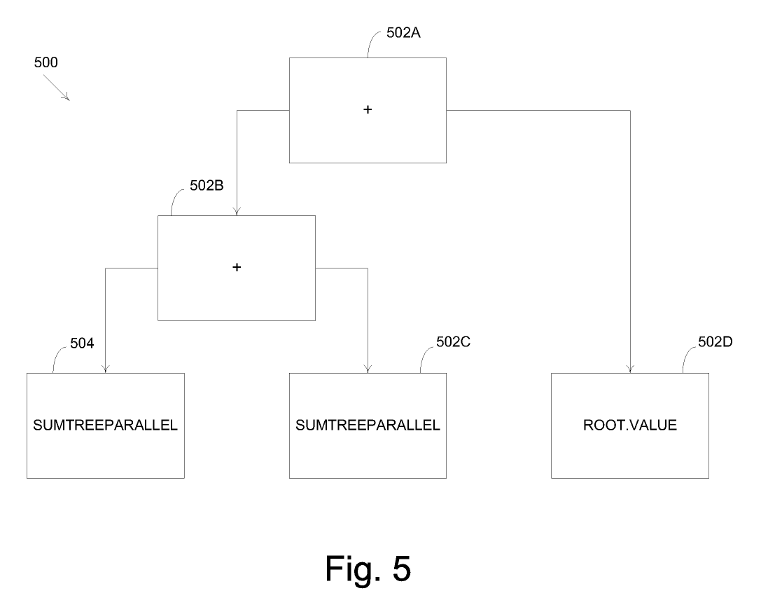

For this example, the code would be compiled and translated into code that is configured at run time to create an expression tree that represents the expression “SumTreeParallel(root.Left, depth−1)+SumTreeParallel(root.Right, depth−1)+root.Value)”. The code would then be executed at run time to create the expression tree. FIG. 5 is a diagram illustrating an expression tree 500 for this example expression according to one embodiment. As shown in FIG. 5, the tree 500 includes five nodes 502A-502D and 504. Node 502A corresponds to the second plus sign in the expression. Node 502B corresponds to the first plus sign in the expression. Node 502C corresponds to the second “SumTreeParallel” method call in the expression. Node 502D corresponds to the “root.Value” property access in the expression. Node 504 corresponds to the first “SumTreeParallel” method call in the expression.

In one embodiment, the parallel expression evaluator 412 (FIG. 4) is configured to cause a plurality of concurrent threads to evaluate the expression tree 500, thereby processing the corresponding expression in a parallel manner. In one embodiment, the parallel expression evaluator 412 is configured to cause nodes 502A-502D to be evaluated synchronously with a first thread (e.g, the main thread), and is configured to evaluate node 504 asynchronously in a future with a second thread. The parallel expression evaluator 412, according to one embodiment, will make one of the recursive SumTreeParallel calls (i.e., the call corresponding to node 504) asynchronously in a future, and hence parallelize the expression. Once the future completes, the parallel expression evaluator 412 adds up the values returned by the synchronous recursive call (node 502C), the asynchronous recursive call (node 504), and the value (node 502D) at the current node in the binary tree, and return the result.

The binary tree example discussed above demonstrates how futures can be used to parallelize expressions. The expression in the binary tree example is a sum of three arguments: two method calls (to the SumTreeParallel method), and one property access (root.Value). In this example, it is assumed that the property access is cheap, and therefore it is executed synchronously with the main thread rather than asynchronously with another thread in a future. It is also assumed that the two method calls are expensive, and therefore one of the methods is executed asynchronously in a future with a second thread, and the other method is executed synchronously with the main thread. After both answers from the two methods are ready, the answers are added together, and the result is added to the property access (root.Value).

In one embodiment, the parallel expression evaluator 412 looks at each node in the expression tree (i.e., each arithmetic operator, method call, etc.) separately, and identifies the nodes that will be expensive to compute and the nodes that will be inexpensive to compute. The parallel expression evaluator 412, according to one embodiment, then computes all but one of the expensive nodes asynchronously in futures using a different thread for each such expensive node, and computes the remaining expensive node synchronously with the main thread. In one embodiment, the inexpensive nodes are simply evaluated by the main thread once they are needed, because it is not expected that they will contribute noticeably to the overall running time.

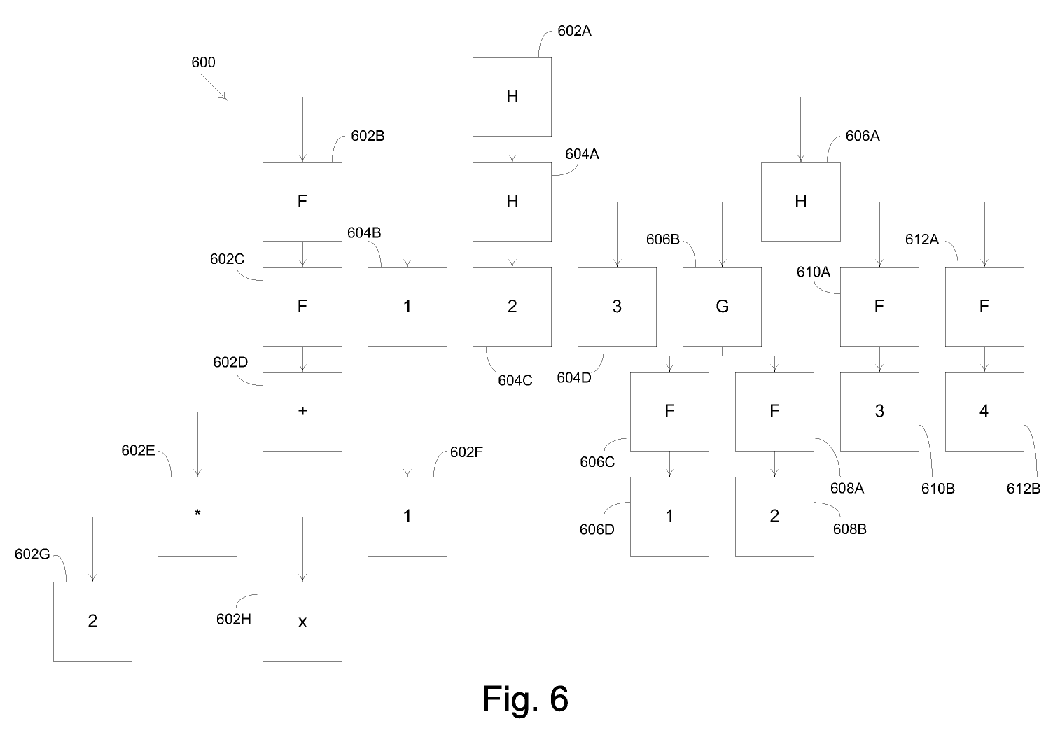

FIG. 6 is a diagram illustrating an expression tree 600 for another example expression according to one embodiment. Expression tree 600 corresponds to the expression “H(F(F(2*x+1)), H(1,2,3), H(G(F(1),F(2)),F(3),F(4))”. As shown in FIG. 6, the tree 600 includes twenty-two nodes 602A-602H, 604A-604D, 606A-606D, 608A-608B, 610A-610B, and 612A-612B. In one embodiment, the parallel expression evaluator 412 is configured to cause nodes 602A-602H to be evaluated synchronously with a first thread (e.g, the main thread), nodes 604A-604D to be evaluated asynchronously in a future with a second thread, nodes 606A-606D to be evaluated asynchronously in a future with a third thread, nodes 608A-608B to be evaluated asynchronously in a future with a fourth thread, nodes 610A-610B to be evaluated asynchronously in a future with a fifth thread, and nodes 612A-612B to be evaluated asynchronously in a future with a sixth thread.

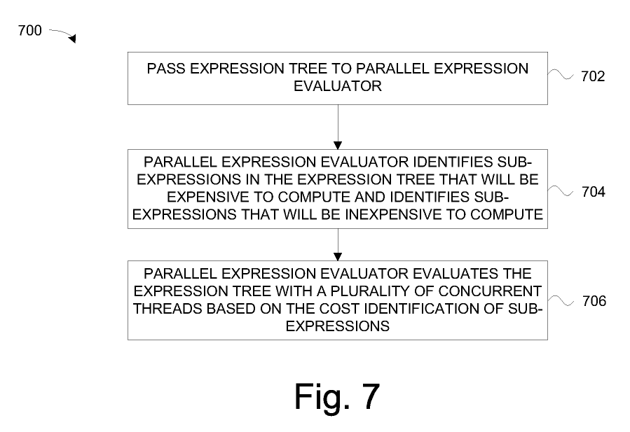

FIG. 7 is a flow diagram illustrating a method 700 for evaluating an expression tree using a plurality of concurrent threads according to one embodiment. In one embodiment, step 308 in method 300 (FIG. 3) is implemented using method 700. At 702, an expression tree 410 is passed to the parallel expression evaluator 412. At 704, the parallel expression evaluator 412 identifies sub-expressions in the expression tree 410 that will be expensive to compute, and identifies sub-expressions that will be inexpensive to compute. At 706, the parallel expression evaluator 412 evaluates the expression tree 410 with a plurality of concurrent threads based on the cost identification of sub-expressions at 704.

In one embodiment, at 706, the parallel expression evaluator 412 evaluates all but one of the expensive sub-expressions asynchronously in futures using a different thread for each such expensive sub-expression, and synchronously evaluates the remaining expensive sub-expressions and all of the inexpensive sub-expressions with a main thread. In one embodiment, the parallel expression evaluator 412 evaluates at least one of the sub-expressions with an asynchronous task. In one embodiment, the asynchronous task is a future.

In one embodiment, the parallel expression evaluator 412 identifies a computational cost for each sub-expression, and determines for each sub-expression whether to evaluate the sub-expression with an asynchronous task based on the identified cost of the sub-expression. In one embodiment, the computational cost for at least one of the sub-expressions is expressed in the sub-expression by a user. In one embodiment, the computational cost for at least one of the sub-expressions is identified automatically based on heuristics. In one embodiment, the computational cost for at least one of the sub-expressions is identified automatically based on a method signature of the sub-expression.

In one embodiment, the parallel expression evaluator 412 identifies each sub-expression as one of computationally expensive or computationally inexpensive, evaluates each computationally inexpensive sub-expression with a main thread, and concurrently evaluates at least one of the computationally expensive sub-expressions with at least one additional thread.

In one embodiment, the parallel expression evaluator 412 is configured to perform run-time compilation of parallel expressions. Processing of an expression tree at run time can have a relatively high overhead. This does not matter if the work involved in evaluating parts of the expression is large, but nevertheless, it is useful to eliminate unnecessary overheads. If a particular parallel expression is going to be evaluated multiple times, the parallel expression evaluator 412 according to one embodiment is configured to process the expression once, and then compile the code that evaluates the expression in parallel at run-time into low-level machine code, which will be directly executed by the processors or a virtual machine.

In one embodiment, the parallel expression evaluator 412 is configured to substitute and use asynchronous alternatives when they exist for sub-expressions. If an expression contains certain types of methods, the parallel expression evaluator 412 may decide to use the asynchronous programming pattern. For example, if the expression contains a procedure call that reads data from disc, the parallel expression evaluator 412 according to one embodiment will replace the method call with an asynchronous method call that will inform the operating system that it is desired to read from the disk. After notifying the operating system, the computational thread can be released and allowed to execute other tasks. Once the file read operation is complete, the operating system will notify the parallel expression evaluator 412, and the value read from disk can be used to proceed further in the computation. In one embodiment, the parallel expression evaluator 412 is configured to identify a sub-expression that can be evaluated using an asynchronous programming pattern method, and evaluate the identified sub-expression using the asynchronous programming pattern method. An advantage of one form of this embodiment is that a computational thread does not have to be blocked while waiting for the asynchronous operation to complete.

In one embodiment, the parallel expression evaluator 412 is configured to eliminate extraneous futures through user-provided information as to the expected computational complexity of individual sub-expressions. The parallel expression evaluator 412 according to one embodiment is configured to identify which sub-expressions are expensive to compute and which are inexpensive to compute, so that it does not unnecessarily pay the cost of scheduling an asynchronous task for an inexpensive sub-expression, such as a sub-expression that adds two numbers. In one embodiment, the parallel expression evaluator 412 uses a heuristic to identify sub-expressions as being either expensive or inexpensive, such as identifying all method calls as being expensive, and all other types of sub-expressions (e.g., arithmetic operators, constructor calls, property accesses, etc.) as being inexpensive. In other embodiments, other heuristics may be used, and information may be specified by the user to suggest the expected cost of evaluating different parts of an expression. In one embodiment, the parallel expression evaluator 412 is configured to look at user-specified attributes of methods contained in an expression (e.g., attributes that indicate the computational cost of the methods), and decide whether to execute those methods asynchronously with futures based on the user-specified attributes.

In one embodiment, the parallel expression evaluator 412 is configured to automatically determine expensive versus inexpensive sub-expressions based on data type and method signatures. Rather than assuming that all method calls are expensive, another heuristic is to estimate the cost of a method call based on data types and method signatures. In one embodiment, the parallel expression evaluator 412 contains a table of methods arranged by type or other criteria, together with values representing the expected costs of calling each method. The parallel expression evaluator 412 uses this information to decide how to parallelize each expression efficiently. In another embodiment, the parallel expression evaluator 412 is configured to examine the number of instructions and the types of instructions in a given method to determine whether the method should be evaluated asynchronously in a future or synchronously in the main thread.

In one embodiment, the parallel expression evaluator 412 is configured to measure the time spent evaluating sub-expressions contained in an expression. By measuring the time spent evaluating different parts of an expression, the parallel expression evaluator 412 can decide whether the overhead spent by scheduling parts of the computation asynchronously is paying off in terms of efficiency. If not, the parallel expression evaluator 412 can revert back to sequential execution. In one embodiment, the parallel expression evaluator 412 is configured to use the time measurement data as a feedback mechanism for self-tuning itself to better parallelize the same expression in the future. In one embodiment, the parallel expression evaluator 412 is configured to measure an amount of time spent evaluating at least one sub-expression, and adjust evaluation of the at least one sub-expression based on the measured amount of time.

In one embodiment, the parallel expression evaluator 412 is a master computational device and is configured to send a portion of an expression or expression tree to a slave computational device for evaluation in parallel with the portion evaluated by the evaluator 412.

One embodiment provides integration of parallelizable expressions with a language supporting expression trees, implementation of parallelizable expressions using futures, and run-time compilation of parallel expressions. In one embodiment, when asynchronous alternatives exist for sub-expressions, these alternatives are automatically substituted and used. In one embodiment, extraneous futures are automatically eliminated based on user-provided information as to the expected computational complexity of individual sub-expressions. In one embodiment, automatic determinations of expensive versus inexpensive sub-expressions are made based on data type and method signatures. In one embodiment, diagnostics for individual sub-expressions are performed, including the determination of timing information, to verify the efficiency and viability of parallelism for individual expressions, as well as to provide a feedback mechanism for self-tuning future parallelization of the same expression.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A computer-readable storage medium storing computer-executable instructions for performing a method comprising:
compiling an expression into executable code that is configured to create a data structure that represents the expression, wherein the expression includes a plurality of sub-expressions;
executing the code to create the data structure; and
evaluating the data structure using a plurality of concurrent threads, thereby processing the expression in a parallel manner.

2. The computer-readable storage medium of claim 1, wherein the data structure is an expression tree.

3. The computer-readable storage medium of claim 1, wherein evaluating the data structure comprises:
evaluating at least one of the sub-expressions with an asynchronous task.

4. The computer-readable storage medium of claim 3, wherein the asynchronous task is a future.

5. The computer-readable storage medium of claim 1, wherein evaluating the data structure comprises:
identifying a computational cost for each of the sub-expressions; and
determining for each sub-expression whether to evaluate the sub-expression with an asynchronous task based on the identified cost of the sub-expression.

6. The computer-readable storage medium of claim 5, wherein the computational cost for at least one of the sub-expressions is expressed in the sub-expression by a user.

7. The computer-readable storage medium of claim 5, wherein the computational cost for at least one of the sub-expressions is identified automatically based on heuristics.

8. The computer-readable storage medium of claim 5, wherein the computational cost for at least one of the sub-expressions is identified automatically based on a method signature of the sub-expression.

9. The computer-readable storage medium of claim 1, wherein evaluating the data structure comprises:
identifying each sub-expression as one of computationally expensive or computationally inexpensive.

10. The computer-readable storage medium of claim 9, wherein evaluating the data structure further comprises:
evaluating each computationally inexpensive sub-expression with a main thread; and
concurrently evaluating at least one of the computationally expensive sub-expressions with at least one additional thread.

11. The computer-readable storage medium of claim 1, wherein evaluating the data structure comprises:
identifying a sub-expression that can be evaluated using an asynchronous programming pattern method; and
evaluating the identified sub-expression using the asynchronous programming pattern method.

12. The computer-readable storage medium of claim 1, wherein the method further comprises:
measuring an amount of time spent evaluating at least one of the sub-expressions; and
adjusting evaluation of the at least one sub-expression based on the measured amount of time.

13. A method of evaluating an expression in a parallel manner, the expression including a plurality of sub-expressions, the method comprising:
providing executable code that is configured to create a data structure that represents the expression;
executing the code to create the data structure; and
evaluating the data structure using a plurality of concurrent threads, thereby processing the expression in a parallel manner.

14. The method of claim 13, wherein the data structure is an expression tree.

15. The method of claim 13, wherein evaluating the data structure comprises:
evaluating at least one of the sub-expressions with an asynchronous task.

16. The method of claim 15, wherein the asynchronous task is a future.

17. The method of claim 13, wherein evaluating the data structure comprises:
identifying each sub-expression as one of computationally expensive or computationally inexpensive.

18. The method of claim 17, wherein evaluating the data structure further comprises:
evaluating each computationally inexpensive sub-expression with a main thread; and
concurrently evaluating at least one of the computationally expensive sub-expressions with at least one additional thread.

19. A computer-readable storage medium storing computer-executable instructions for performing a method comprising:
compiling an expression into executable code that is configured to create a data structure that represents the expression;
executing the code to create the data structure;
evaluating a first portion of the data structure using a first thread; and
concurrently evaluating a second portion of the data structure using a second thread.

20. The computer-readable storage medium of claim 19, wherein the data structure is an expression tree.
